(19) United States
(12) Patent Application Publication
(10) Pub. No.: US 2023/0387636 A1
(43) Pub. Date: Nov. 30, 2023

(54) SYSTEM AND METHOD FOR ELECTRICAL RECEPTACLE IN-USE SENSING DETECTION

(71) Applicant: Metropolitan Industries, Inc., Romeoville, IL (US)

(72) Inventors: John R. Kochan, JR., Naperville, IL (US); James Andrew Nimmer, Minooka, IL (US)

(21) Appl. No.: 18/323,972

(22) Filed: May 25, 2023

Related U.S. Application Data
(60) Provisional application No. 63/346,209, filed on May 26, 2022.

(51) Int. Cl. H01R 13/66

(52) U.S. Cl. CPC H01R 13/6691; H01R 13/6683; H01R 2105/00

(57) ABSTRACT

An electrical receptacle is provided. The electrical receptacle can include a hot slot, a neutral slot, and an in-use contact terminal. The hot slot can include a line contact terminal. The neutral slot can include a neutral contact terminal. The in-use contact terminal can be located within the hot slot. The in-use contact terminal can be adjacent to the line contact terminal and can make contact with a hot lead when a power cord is connected to the electrical receptacle.

### BACKGROUND

The subject disclosure is generally related to a sensing circuit for an electrical connector, and more particularly to an electrical receptacle having an in use sense input or contact terminal that can interface with the contact of a male connector or plug to form an in-use circuit, the disruption of which can produce a signal alerting to an unplugged condition.

It is generally understood that electrical connectors are electromechanical devices used to create an electrical connection between different electrical circuits or devices, including connection of electrical equipment to a power supply. Ordinarily, plug-and-socket-type electrical connectors include a male plug component commonly having protruding male contacts, and a female receptacle component having recessed female contacts for receiving male contacts.

Certain critical or essential electrically powered equipment or devices can require a constant supply of power such that a failure or disruption of electricity can render them inoperable and result in serious or catastrophic damage, loss, injury or death. Examples of such critical equipment can include critical health or life-support equipment such as ventilators or medical pumps, artificial refrigeration appliances such as a refrigerator or freezer used in connection with medical or commercial food storage applications, security system equipment, business or government-critical computer servers and water pumps such as sump pumps.

In certain instances, a power disruption can occur in such critical equipment from the device being unintentionally unplugged without a manager, owner or supervisor being aware of such condition. Where such condition occurs, it may not be detected or realized until the harm or damage is incurred and discovered. Thus, determining whether an electrical connection exists, and more particularly detecting whether an electrical plug has been unplugged from (or not fully plugged into) a receptacle, can be essential for the delivery of constant power to such critical equipment and devices.

### BRIEF SUMMARY

A system and method for electrical receptacle in-use sensing detection is provided according to various embodiments.

In one aspect, an electrical receptacle is provided. The electrical receptacle can include a hot slot, a neutral slot, and an in-use contact terminal. The hot slot can include a line contact terminal. The neutral slot can include a neutral contact terminal. The in-use contact terminal can be located within the hot slot. The in-use contact terminal can be adjacent to the line contact terminal and can make contact with a hot lead when a power cord is connected to the electrical receptacle.

In a second aspect, a method is provided. The method may include a computing device obtaining an in-use signal from an electrical receptacle. The electrical receptacle may include a hot slot and an in-use contact terminal. The in-use contact terminal may be located within the hot slot. The in-use contact terminal may be adjacent to the line contact terminal and may make contact with a hot lead when a power cord is connected to the electrical receptacle. The computing device may also determine a state of the electrical receptacle based on the in-use signal. The computing device may further output an alert based on the state of the electrical receptacle.

In a third aspect, a non-transitory computer-readable storage medium storing a plurality of programs for execution by a computing device having one or more processors is provided. When the plurality of programs, when executed by the one or more processors, cause the computing device to perform obtaining an in-use signal from an electrical receptacle. The electrical receptacle may include a hot slot and an in-use contact terminal. The in-use contact terminal may be located within the hot slot. The in-use contact terminal may be adjacent to the line contact terminal and may make contact with a hot lead when a power cord is connected to the electrical receptacle. The plurality of programs may additionally further cause the computing device to perform determining a state of the electrical receptacle based on the in-use signal. The state of the electrical receptacle may include a plugged-in state, an unplugged state, and a transition plug state. The plurality of programs may additionally further cause the computing device to perform outputting an alert based on the state of the electrical receptacle.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1A is a schematic view of an in-use sensing system in a not-in-use state, according to exemplary embodiments presented herein.

FIG. 1B is a schematic detail view of an in-use contact terminal and line contact terminal of the in-use sensing system of FIG. 1A.

FIG. 2 is a schematic view an in-use sensing system in an in-use state, according to exemplary embodiments presented herein.

FIG. 3 is a schematic diagram of in-use sensing circuitry, according to exemplary embodiments presented herein.

FIG. 4 is a perspective view of an electrical receptacle, according to exemplary embodiments presented herein.

FIG. 5 is a front view of the electrical receptacle of FIG. 4.

FIG. 6 is a back view of the electrical receptacle of FIG. 4.

FIG. 7 is a back cutaway view of the electrical receptacle of FIG. 4 with a removed back cover.

FIG. 8 is a front cutaway view of the electrical receptacle of FIG. 4 with a removed front cover.

FIG. 9 is a schematic view of an in-use sensing circuitry of FIG. 4.

FIG. 10 is a flow diagram illustrating a method for electrical receptacle in-use sensing detection, for electrical receptacle in-use sensing detection.

FIG. 11 is a schematic block illustration of a computing environment, according to exemplary embodiments presented herein.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular. The words “first,” “second,” “third,” and the like may be used in the present disclosure to describe various information, such information should not be limited to these words. These words are only used to distinguish one category of information from another. The directional words “top,” “bottom,” up,” “down,” front,” “back,” and the like are used for purposes of illustration and as such, are not limiting. Depending on the context, the word “if” as used herein may be interpreted as “when” or “upon” or “in response to determining.”

The present disclosure relates to an electrical receptacle or socket used to detect an unplugged electrical plug. The receptacle may power critical equipment (pumps, servers, medical equipment, etc.) through a power cord that includes a plug or male connector. The power cord may unintentionally be unplugged from the receptacle, and a user may be unaware of the condition of the power cord and receptacle until the resulting damage or hazardous outcome occurs from a lack of power to the critical equipment.

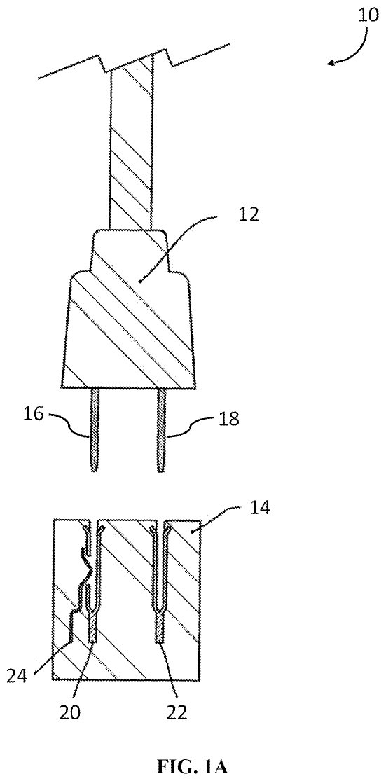

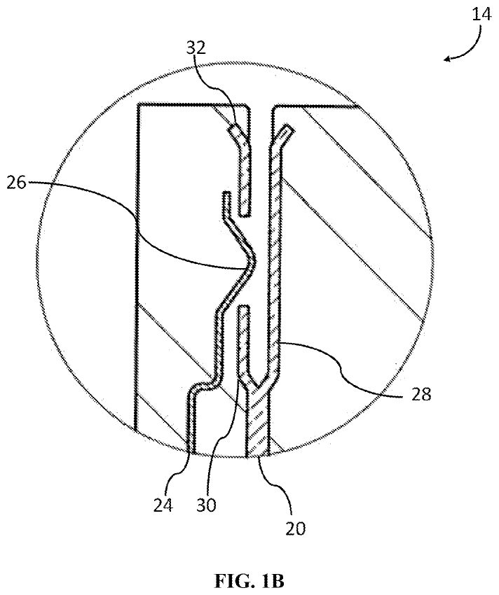

Referring now to the figures, FIG. 1A to FIG. 3 schematically show an in-use sensing system according to exemplary embodiments presented herein.

FIGS. 1A and 1B show an in-use sensing system 10 according to exemplary embodiments. Specifically, FIG. 1A shows an electrical plug 12 that connects to a receptacle 14. The electrical plug 12 can include a hot lead 16 and a neutral lead 18. The receptacle 14 can provide an electrical load and an in-use sensing receptacle 24. As shown schematically in FIG. 1A, receptacle 14 can have a line contact terminal 20 and neutral contact terminal 22. The line contact terminal 20 can include an in-use contact terminal 24 according to exemplary embodiments shown schematically in FIG. 1A. FIG. 1B shows the line contact terminal 20 with an in-use contact terminal 24 in accordance with representative embodiments. FIGS. 1A and 1B show a receptacle state when it is not in use, or the electrical plug 12 is not plugged into receptacle 14. In such state, the in-use contact terminal 24 can be electrically isolated from the line contact terminal 20 as shown representatively. The in-use contact terminal 24 can include a contact area 26 that is shaped to make contact with the line contact terminal 20 when the line contact terminal 20 is received in the receptacle 14. The contact area 26 can be a triangular shape that extends between a first and second section 30, 32 of the line contact terminal 20.

In an embodiment, the line contact terminal 20 can be a terminal where the ‘live’ or ‘hot’ wire connects. The neutral contact terminal 22 can complete the electrical circuit by providing the path back to the electrical panel. The neutral wire can be connected to earth/ground at an electrical panel, which means it has nearly zero voltage. Therefore, the neutral terminal is generally safe to touch and doesn't pose the same risk as touching the line contact terminal.

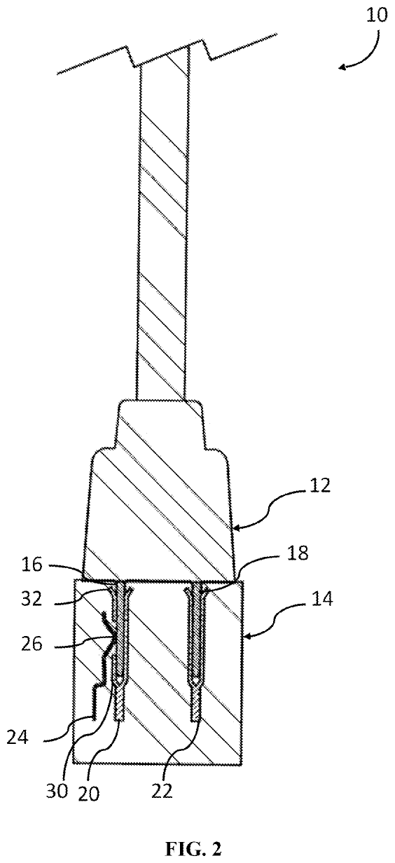

FIG. 2 shows a in-use sensing system 10 in a closed state when it is in use, or the electrical plug 12 is inserted into the receptacle 14 according to exemplary embodiments. As shown schematically in FIG. 2, an electrical contact can be made between the in-use contact terminal 24 at the contact area 26 and the line contact terminal 20 through the load power cord plug end contact 16, and more particularly from the male contact interfacing with the in-use contact terminal.

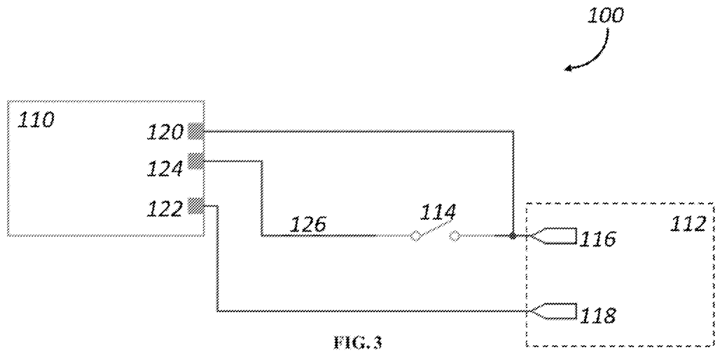

FIG. 3 shows an electrical schematic of the in-use sensing system 100 according to exemplary embodiments. As shown schematically in FIG. 3, the in-use sensing circuitry 110 can include a line input 118, a in use sense input 122, and a neutral input 120. The line input 118 and neutral input 120 can provide power to the power cord 12 using a receptacle 112 with hot line 116 and neutral line 118. The switch 114 can be within the receptacle 14 and provide a in use contact 126 of “high” to the in use sense input when the power cord 12 is connected to the receptacle and a “low” when the power cord is not connected.

According to embodiments shown schematically in FIG. 3, the in_use_contact signal 124 can be used to communicate to a user the status of the power cord 12 connection. For example, the in_use_contact signal 124 can be used to transmit a notification or alarm to a user by a light and/or sound on the receptacle 14. In another example, the in_use_contact signal 124 may be used to transmit a notification or alarm to a system that can alert a user or log the status. The system may be a processing unit or circuit board that handles such notifications. In another example, the in_use_contact signal 124 may be used to transmit a notification or alarm to a user, such as to a computer or mobile electronic device, by way of a transmitter sending such notification via a public or private wired or wireless network.

According to exemplary embodiments presented herein, a receptacle 14 or socket can receive a standard electrical plug 12. The receptacle 14 can include a contact 26 (mainly a conductive terminal having a portion within one of the female connector sockets of the receptacle) that forms a circuit when the plug is engaged. Upon disengagement, the circuit can be disrupted and a signal can be generated. The signal can generate an alert that may be sent via a wired or wireless network to alert a user about the condition of the receptacle.

According to exemplary embodiments presented herein, the receptacle 14 can include a contact 26 that forms a circuit when the plug is disengaged. Upon engagement, the circuit can be disrupted and a signal can be generated. For example, an in use contact terminal 24 may be in contact with the line contact terminal 20 when the hot lead 16 is disengaged and when the hot lead 16 is engaged, the hot lead 16, which may make contact with an insulated section of the in use contact terminal 20, disengages or breaks the contact between the in use contact terminal 24 and the line contact terminal 20.

According to exemplary embodiments, an electrical plug 12 can power loads that include critical equipment (pumps, servers, medical equipment, etc.) and plug 12 may unintentionally be unplugged with a user being unaware of the condition until the resulting damage or hazardous outcome occurs from a lack of power to the device.

According to exemplary embodiments, the hot lead 16 and neutral lead 18 of the plug can complete the sensing circuit when the device is plugged in and when it is unplugged, there can be an alert sent either back through the electrical wiring system, a wired network, wirelessly via BLUETOOTH, WIFI, or other wireless network communications, or to internal components for audible and visible indication. The receptacle according to embodiments presented herein may comprise a wireless transmitter for transmitting such alert and may comprise a piezoelectric element and LED for audible and visible indication of such alert.

According to exemplary embodiments, the in-use sensing system 10 can determine engagement between connectors of a plug 12 and socket 14 by the in-use contact terminal/arm 24. As show schematically in FIGS. 1A, 1B, and 2, at least a portion of the in-use contact 24 can reside along (and/or extend through) a side opening (between the first and second section 30, 32) of the sidewall of the female connector/socket of the line contact and be capable of push engagement with the male connector pin of the plug. The in-use sensing system 10 can include disengagement by the pin moving past the open portion actuating the movement of the terminal to disrupt the circuit generating an alert signal.

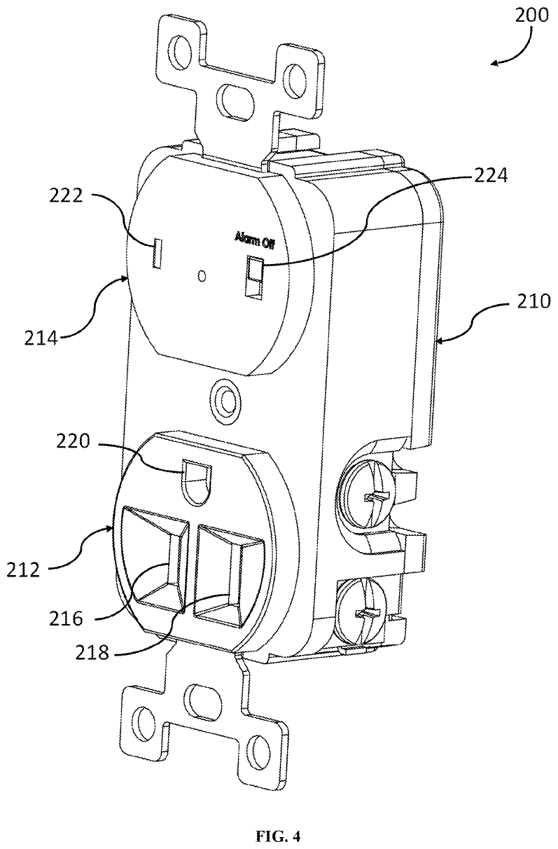

FIG. 4 shows a perspective view of a receptacle 200, according to exemplary embodiments presented herein. As shown schematically in FIG. 4, the receptacle 200 can include a receptacle body 210, a single receptacle slot 212, and a user interface 214. The single receptacle slot 212 can include a hot slot 216, neutral slot 218, and ground slot 220. The user interface 214 can include an alarm on/off switch 224 and status LED 222. The receptacle 200 can be an electrical receptacle, also known as an outlet, that can provide a point at which electrical appliances and devices can be plugged in to access an electrical supply. By connecting a device's electrical plug to the receptacle slot 212, electrical current can transfer from the power source to the device, enabling it to function or charge. The receptacle slot 212 can include an in-use contact terminal 232 for detecting an unplugged electrical plug.

In an embodiment, the electrical receptacle 200 can include a plugged-in state where the electrical plug 12 is connected to the receptacle 14, an unplugged state where the electrical plug 12 is not plugged into the receptacle 14, and a transition plug state where the electrical plug 12 is being unplugged or there is a lose connection. In an embodiment, the user interface can be used to alert a user of each of the states.

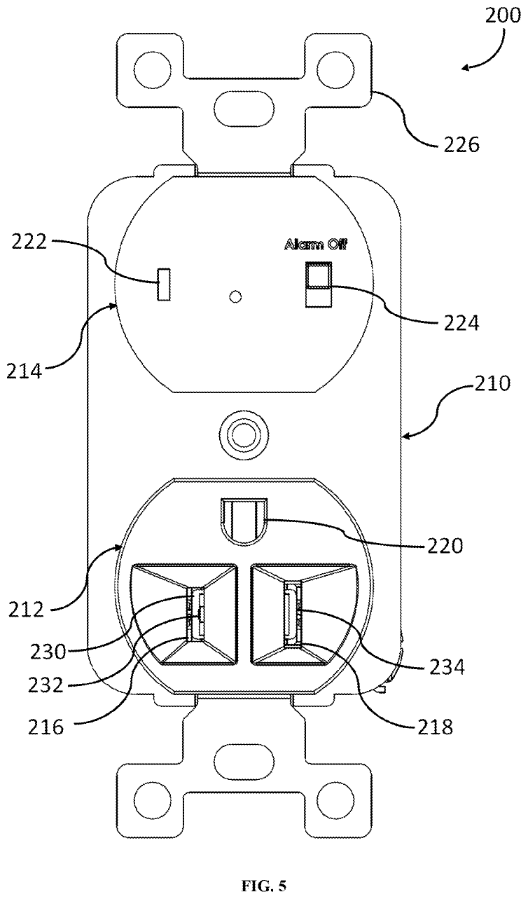

FIG. 5 shows a front view of the receptacle 200 of FIG. 4. As shown schematically in FIG. 5, the receptacle 200 can include the in-use contact terminal 232 within the hot slot 216. The slots 216, 218 can include line contact terminal 230 and neutral contact terminal 234, respectively.

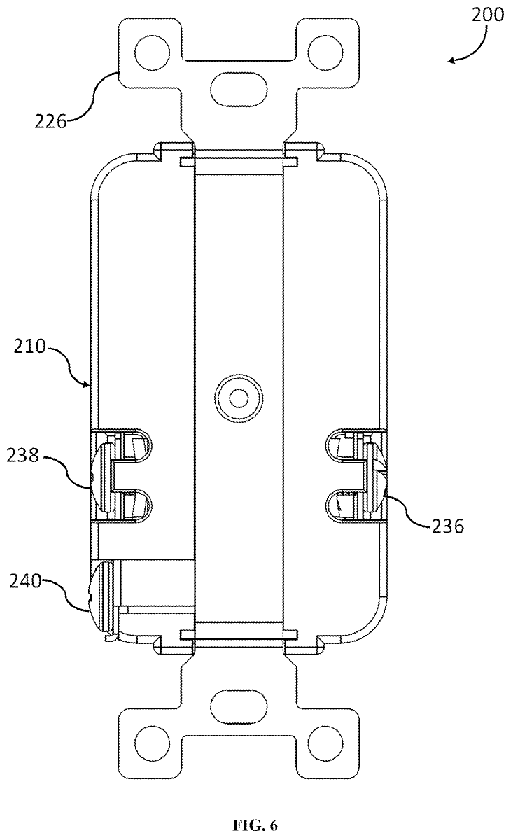

FIG. 6 shows a back view of the receptacle of FIG. 4. As shown schematically in FIG. 6, the receptacle can include mounting ears or yokes 226 and screw connectors 236, 238, 240. The mounting ears 226 can be used for mounting the receptacle 200 to an electrical box. The screw connectors 236, 238, 240 can be a line terminal screw connector 236, a neutral terminal screw connector 238, and an earth ground terminal screw connector 240. The screw connectors 236, 238, 240 can be used to connect to a power supply, for example, a building's or home's breaker box that is connected to an electrical grid.

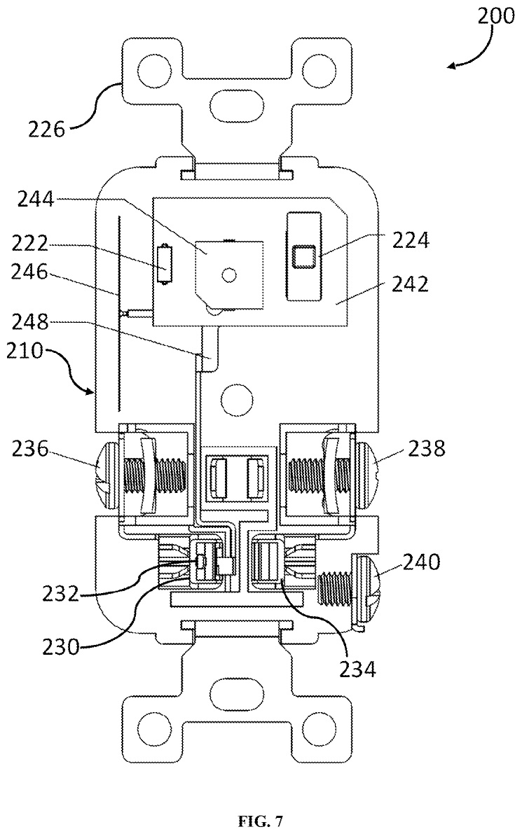

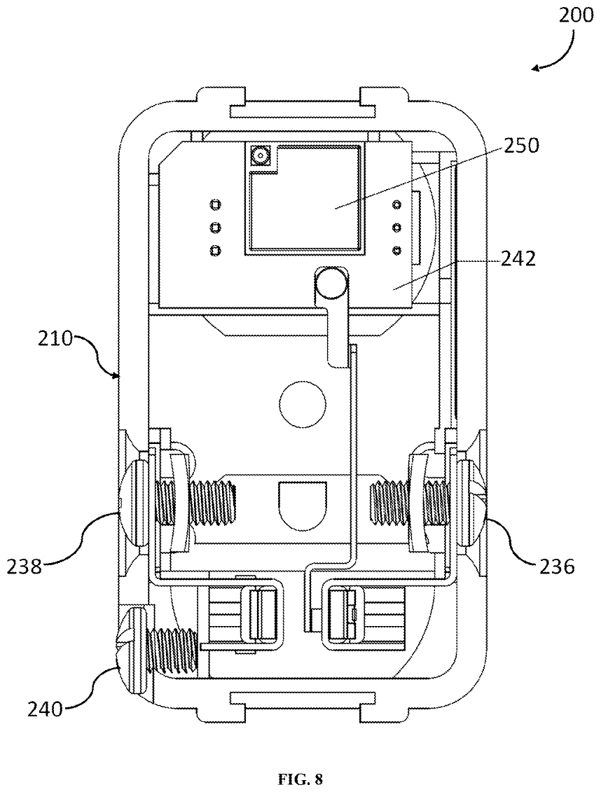

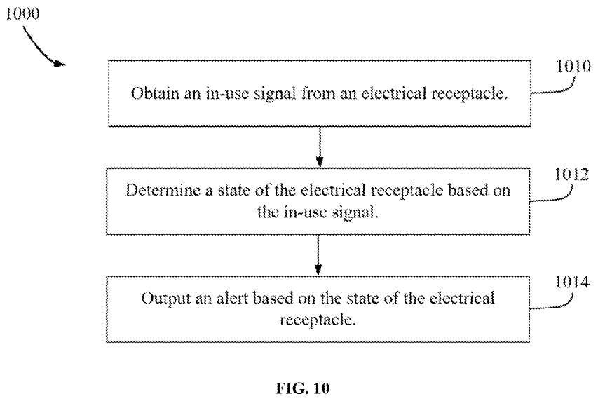

FIG. 7 shows a back cutaway view of the receptacle 200 of FIG. 4 with a removed back cover. As shown schematically in FIG. 7, the receptacle 200 can include an LED 222, an alarm control switch 224, a printed circuit board (PCB) 242, an alarm buzzer 244, a wireless transceiver antenna 246, a sense contact PCB connection 248. The PCB connection 248 can be coupled to the in-use contact terminal 232 for detecting a connection on the receptacle 200. The LED 222, alarm control switch 224, and alarm buzzer 244 can be part of the user interface for controlling the alarm system on the receptacle 200. For example, the alarm can be turned on to output a sound alarm on the alarm buzzer 244 when a connection, open connection, or change of connection is detected on the receptacle 200 through the sense contact PCB connection 248 and in-use contact terminal 232. The PCB 242 can include a computational system for processing data from the sense contact PCB connection 248 and in-use contact terminal 232 and controlling the user interface 222, 224, 244 and communicating with other devices like a smartphone or server (FIG. 10). The wireless transceiver antenna 246 can be used with a wireless transceiver 250 (FIG. 8) to communicate with external devices like a smartphone.

FIG. 8 shows a front cutaway view of the receptacle of FIG. 4 with a removed front cover. As shown schematically in FIG. 8, the receptacle 200 can include the wireless transceiver 250 for communicating with external devices.

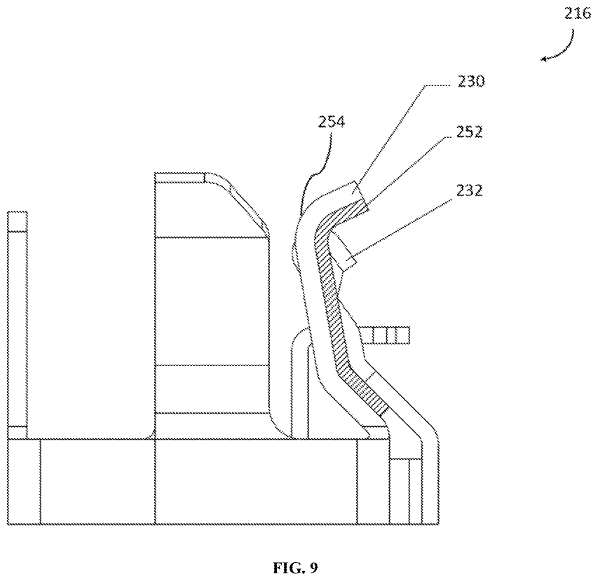

FIG. 9 shows a schematic view of hot slot 216 of FIG. 4. As shown schematically in FIG. 9, the hot slot 216 can include the line contact terminal 230, the in-use contact terminal 232 and an insulation layer 252. The insulation layer 252 can insulate the line contact terminal 230 from the in-use contact terminal 232. In an embodiment, the line contact terminal can have a u-shaped or horseshoe design that allows for contact with the hot lead 16 at a contact edge 254 of the line contact terminal 230 and an opening away from the contact edge 254 for the in-use contact terminal 232 to operate in.

In an embodiment, the in-use contact terminal 232 can be positioned in a slotted hole (for example, the u-shaped opening away from the contact edge 254) within the line contact terminal 230. The insulation layer 252 can be positioned within the slotted hole on both sides of the in-use contact terminal 232. The insulation layer 252 can prevent the in-use contact terminal 232 from making contact with the line contact terminal 230 in an unplugged state and can prevent deformation of the in-use contact terminal 232 during a transition of plugging in or unplugging a power cord 12. The insulation layer 252 can be fixed to the in-use contact terminal 232 and can move with a 1-5 degree of freedom (for example, one degree) within the slotted hole of the line contact terminal 230. The in-use contact terminal 232 can protrude past the surface of the insulation layer 252 allowing the in-use contact terminal 232 to make electrical contact with the hot lead 16 when in a plugged-in state.

FIG. 10 shows a method 1000 for electrical receptacle in-use sensing detection, according to example embodiments. The method may be applied to a computing device such as a PCB 242.

In step 1010, the computing device can obtain an in-use signal from an electrical receptacle. For example, an in-use signal can be generated by the in-use contact terminal 232 when the hot lead 16 is connected to the line contact terminal 20. The in-use signal can be read from the sense contact PCB connection 248.

In step 1012, the computing device can determine a state of the electrical receptacle based on the in-use signal. For example, the in-use signal can be high when the hot lead 16 is connected to the line contact terminal 20. The computing device can use the high signal to determine that the state of the electrical receptacle is plugged in.

In step 1014, the computing device can output an alert based on the state of the electrical receptacle. For example, the computing device can output an alarm when the state of the electrical receptacle is plugged in.

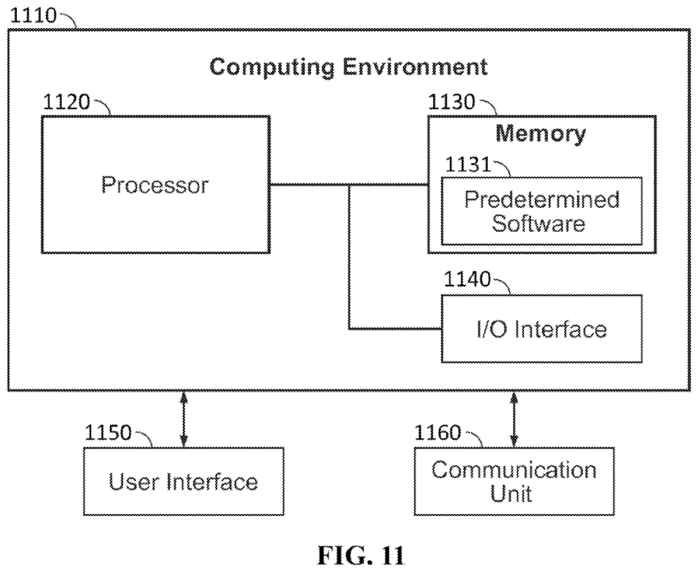

FIG. 10 shows a computing environment 1110 that can be part of the receptacle 14, 112, 200 and/or PCB 242. According to example embodiments shown schematically in FIG. 11, the computing environment 1110 can be connected to a user interface 1150 and a communication unit 1160. The computing environment 1110 can include a processor 1120, a memory 1130, and an I/O interface 1140.

The processor 1120 can typically control the overall operations of the computing environment 1110, such as the operations associated with data acquisition, data processing, and data communications. The processor 1120 can include one or more processors to execute instructions to perform all or some of the steps in the above-described methods. Moreover, the processor 1120 can include one or more modules that facilitate the interaction between the processor 1120 and other components. The processor may be or include a Central Processing Unit (CPU), a microprocessor, a single chip machine, a graphical processing unit (GPU) or the like.

The memory 1130 can store various types of data to support the operation of the computing environment 1110. Memory 1130 can include predetermined software 1131. Examples of such data include instructions for any applications or methods operated on the computing environment 1110, current data, voltage data, etc. The memory 1130 may be implemented by using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1140 can provide an interface between the processor 1120 and peripheral interface modules, such as an external port, an audio and speaker circuitry, input controllers, light output including LEDs, switch, and buttons. The buttons and switches may include but are not limited to, a settings button or switch, and a power button or switch.

The user interface 1150 can include speaker, lights, display or other similar technologies for communicating with the user.

Communication unit 1160 provides communication between the processing unit, an external device, mobile device, and a webserver (or cloud). The communication can be done through, for example, WIFI or BLUETOOTH hardware and protocols. The communication unit 1160 can be within the computing environment or connected to it.

In some embodiments, there is also provided a non-transitory computer-readable storage medium comprising a plurality of programs, such as comprised in the memory 1130, executable by the processor 1120 in the computing environment 1110, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 1110 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. An electrical receptacle comprising:
a hot slot, wherein the hot slot comprises a line contact terminal;
a neutral slot, wherein the neutral slot comprises a neutral contact terminal; and
an in-use contact terminal, wherein the in-use contact terminal is located within the hot slot, wherein the in-use contact terminal is adjacent to the line contact terminal and makes contact with a hot lead when a power cord is connected to the electrical receptacle.

2. The electrical receptacle of claim 1, wherein the line contact terminal comprises a side opening, wherein the in-use contact terminal is located within the side opening for contacting with the hot lead.

3. The electrical receptacle of claim 1, wherein the line contact terminal comprises a u-shape and the in-use contact terminal is located within the u-shape for contacting with the hot lead.

4. The electrical receptacle of claim 1, further comprising:
a sensing circuit, wherein the sensing circuit comprises a printed circuit board (PCB) and a sense contact PCB connection, wherein the sense contact PCB connection is coupled to the in-use contact terminal and PCB, wherein the PCB is configured to detect a state of the electrical receptacle based on the in-use contact terminal.

5. The electrical receptacle of claim 4, wherein the state of the electrical receptacle comprises a plugged-in state, an unplugged state, and a transition plug state.

6. The electrical receptacle of claim 5, wherein the in-use contact terminal outputs an in-use signal based on the hot lead being plugged into the hot slot, wherein the PCB determines the state of the electrical receptacle based on the in-use signal.

7. The electrical receptacle of claim 6, wherein the in-use signal comprises high when the hot lead engages the hot slot.

8. The electrical receptacle of claim 6, wherein the in-use signal comprises high when the in-use contact terminal is open.

9. The electrical receptacle of claim 5, further comprising:
a user interface, wherein the user interface comprises an alarm buzzer that activates based on the state of the electrical receptacle.

10. The electrical receptacle of claim 9, wherein the user interface further comprises an alarm control switch.

11. The electrical receptacle of claim 5, further comprising:
a wireless transceiver, wherein the wireless transceiver outputs the state of the electrical receptacle.

12. A method comprising:
obtaining an in-use signal from an electrical receptacle, wherein the electrical receptacle comprises a hot slot with a line contact terminal and an in-use contact terminal, wherein the in-use contact terminal is located within the hot slot, wherein the in-use contact terminal is adjacent to a line contact terminal and makes contact with a hot lead when a power cord is connected to the electrical receptacle;
determining a state of the electrical receptacle based on the in-use signal; and
outputting an alert based on the state of the electrical receptacle.

13. The method of claim 12, wherein the state of the electrical receptacle comprises a plugged-in state, an unplugged state, and a transition plug state.

14. The method of claim 12, wherein determining the state of the electrical receptacle based on the in-use signal comprises:
determining the in-use signal is high, wherein the in-use signal is high when the hot lead engages the hot slot; and
determining the state of the electrical receptacle is a plugged-in state.

15. The method of claim 12, wherein determining the state of the electrical receptacle based on the in-use signal comprises:
determining the in-use signal is high, wherein the in-use signal is high when the in-use contact terminal is open; and
determining the state of the electrical receptacle is an unplugged state.

16. The method of claim 12, wherein determining the state of the electrical receptacle based on the in-use signal comprises:
determining the in-use signal has a signal transition; and
determining the state of the electrical receptacle is a transition plug state.

17. The method of claim 12, wherein outputting the alert based on the state of the electrical receptacle comprises:
outputting a sound alarm the state of the electrical receptacle is an unplugged state.

18. A computing device comprising:
one or more processors;
a non-transitory computer-readable storage medium storing instructions executable by the one or more processors, wherein the one or more processors are configured to:
obtain an in-use signal from an electrical receptacle, wherein the electrical receptacle comprises a hot slot with a line contact terminal and an in-use contact terminal, wherein the in-use contact terminal is located within the hot slot, wherein the in-use contact terminal is adjacent to the line contact terminal and makes contact with a hot lead when a power cord is connected to the electrical receptacle;
determine a state of the electrical receptacle based on the in-use signal, wherein the state of the electrical receptacle comprises a plugged-in state, an unplugged state, and a transition plug state; and
output an alert based on the state of the electrical receptacle.

19. The computing device of claim 18, wherein the one or more processors configured to determine the state of the electrical receptacle based on the in-use signal value are further configured to:
determine the in-use signal is high, wherein the in-use signal is high when the hot lead engages the hot slot; and
determine the state of the electrical receptacle is a plugged-in state.

20. The computing device of claim 18, wherein the one or more processors configured to output the alert based on the state of the electrical receptacle are further configured to:
output a sound alarm the state of the electrical receptacle is an unplugged state.
